(19) United States
(12) Patent Application Publication
(10) Pub. No.: US 2012/0183254 A1
(43) Pub. Date: Jul. 19, 2012

(54) OPTICAL 90-DEGREE HYBRID

(75) Inventor: Takashi INOUE, Tokyo (JP)

(73) Assignee: FURUKAWA ELECTRIC CO., LTD., Tokyo (JP)

(21) Appl. No.: 13/364,611

(22) Filed: Feb. 2, 2012

Related U.S. Application Data
(63) Continuation of application No. PCT/JP2011/062710, filed on Jun. 2, 2011.

(30) Foreign Application Priority Data
Jun. 8, 2010 (JP) 2010-130691

(51) Int. Cl. G02B 6/125

(52) U.S. Cl. 385/14

(57) ABSTRACT

An optical 90-degree hybrid includes a 90-degree hybrid circuit which mixes signal light and local oscillation light (LO light), separates the signal light into orthogonal components I, Q to output. The 90-degree hybrid circuit includes a first and a second coupler that branch signal light and LO light, a first and a second path through which signal light propagates, a third and a fourth path through which LO light propagates, and a third and a fourth coupler that combine signal light and LO light. A phase difference of 90 degrees is given between the beams of LO light propagating through the third and fourth paths. The second coupler, the third path, and the fourth path are formed between the first path and the second path. The overall size of the 90-degree hybrid circuit is reduced and downsizing of the PLC chip is enabled.

### CROSS-REFERENCES TO RELATED APPLICATIONS

This application is a continuation application of International Application No. PCT/JP2011/062710, filed Jun. 2, 2011, which claims the benefit of Japanese Patent Application No. 2010-130691, filed Jun. 8, 2010. The contents of the aforementioned applications are incorporated herein by reference in their entities.

### TECHNICAL FIELD

The present invention relates to an optical 90-degree hybrid using a planar lightwave circuit, such as a quartz-based PLC, used in a receiver for coherent optical transmission system that mixes signal light and local oscillation light, for example, a receiver for DP-QPSK modulation system that receives a DP-QPSK signal.

### BACKGROUND ART

As a prior-art technology, an optical 90-degree hybrid is known, which has a structure of a combination of a coupler and a polarization beam splitter (PBS) on a PLC, such as a quartz-based planar lightwave circuit (PLC) (see Non-Patent Documents 1 to 3).

In general, in a conventional optical 90-degree hybrid used in a receiver for DP-QPSK (Dual Polarization-Quadrature Phase Shift Keying) modulation system etc., as shown in FIG. 6, after a phase-modulated signal (signal light), such as a QPSK signal, and local oscillation light (LO light) are branched by couplers (first coupler 101 and second coupler 102) on the input side, respectively, the signal light and the LO light are combined by couplers (third coupler 103 and fourth coupler 104) on the output side. The two beams of signal light branched by the first coupler 101 on the input side propagate through paths (paths 1, 3) of the same optical path length, respectively, and enter the couplers (the third coupler 103 and the fourth coupler 104) on the output side. On the other hand, two paths (paths 2, 4) through which the beams of LO light branched by the second coupler 102 on the input side propagate, respectively, are caused to have an optical path length difference so that a phase difference of 90 degrees is given between both the beams of LO light. That is, the paths 2, 4 are set so that the optical path length difference is 90 degrees in terms of phase. Due to this, in the third coupler on the output side, the signal light having propagated through the path 1 and the LO light having propagated through the path are combined and in the fourth coupler on the output side, the signal light having propagated through the path 3 and the LO light having propagated through the path 4 are combined (mixed).

[Patent Document 1] Japanese Patent Laid-Open No. 2009-192746

[Non-Patent Document 1] Y. Inoue et al., “Optical 90-degree Hybrid using Quartz-based PLC” 1994 Autumn IEICE Conference, C-259

[Non-Patent Document 2] M. Hosoya et al., “Construction Technology of 90° Hybrid Balanced Optical Receiver Module Using PLC” IEICE Technical Research Report, Optical Communication System OCS-95 pp. 49-54

[Non-Patent Document 3] S. Norimatsu et al., “An Optical 90-Hybrid Balanced Receiver Module Using a Planar Lightwave Circuit,” IEEE Photon. Technol. Lett., Vol. 6, No. 6, pp.737-740 (1994)

### SUMMARY OF INVENTION

However, the above-mentioned conventional optical 90-degree hybrid has the following problems.
(1) On the PLC chip, an optical waveguide is formed in such a manner that one of the two paths through which the signal light propagates (path 3) and one of the two paths through which the LO light propagates (path 2) intersect and the four paths 1 to 4 respectively extending in the horizontal direction of the chip are put side by side at substantially the regular intervals in the longitudinal direction (direction perpendicular to the horizontal direction in the chip plane). Because of this, the dimension in the longitudinal direction of the entire 90-degree hybrid circuit, which is a planar lightwave circuit formed on the PLC chip, is increased and the size of the PLC chip itself is increased.
(2) Because of the increase in the size of the PLC chip itself, it is difficult to reduce the manufacturing cost by increasing the number of 90-degree hybrid circuits that can be manufactured from one wafer, that is, the number of PLC chips obtained from one wafer.

An object of the present invention is to provide an optical 90-degree hybrid which can be downsized and for which the manufacturing cost is reduced.

In order to solve the above-mentioned problems, first aspect of the present invention is an optical 90-degree hybrid in which a 90-degree hybrid circuit that mixes modulated signal light and local oscillation light, separates the signal light into orthogonal components I, Q, and outputs the components is formed within a planar lightwave circuit of a PLC chip, the 90-degree hybrid circuit comprising: a first coupler that branches the signal light; a second coupler that branches the local oscillation light; a first path and a second path through which the signal light branched by the first coupler propagates, respectively; a third path and a fourth path through which the local oscillation light branched by the second coupler propagates, respectively; a third coupler that combines the signal light having propagated through the first path and the local oscillation light having propagated through the third path; and a fourth coupler that combines the signal light having propagated through the second path and the local oscillation light having propagated through the fourth path, wherein the 90-degree hybrid circuit is configured so that a phase difference of degrees is given between the beams of local oscillation light propagating through the third path and the fourth path, and the second coupler, the third path, and the fourth path are formed between the first path and the second path.

A second aspect of the present invention is the optical 90-degree hybrid according to the first aspect, wherein the first path and the second path, and the third path and the fourth path are formed symmetrical about a virtual center line connecting each center part of an input end and an output end of the PLC chip.

A third aspect of the resent invention is the optical 90-degree hybrid according to the second aspect, wherein at the input end, a first input port to which the signal light is input and a second input port to which the local oscillation light is input are provided, respectively, and at the output end, first to fourth output ports are provided, respectively.

A fourth aspect of the present invention is the optical 90-degree hybrid according to the third aspect, wherein between the first input port and the first coupler, a first input waveguide for signal light is formed, between the second input port and the second coupler, a second input waveguide for local oscillation light intersecting any one of the first path and the second path is formed, and a first and a second output waveguide that connect two output ports of the third coupler and the first and second output ports, and a third and a fourth output waveguide that connect two output ports of the fourth coupler and the third and fourth output ports are formed symmetrical about the virtual center line, respectively

A fifth aspect of the present invention is the optical 90-degree hybrid according to the first aspect, wherein the third path and the fourth path have a bent waveguide and a linear waveguide, respectively, and the optical path difference between the third path and the fourth path is set to 90 degrees in terms of phase by adjusting at least one of the rotation angle of the bent waveguide and the length of the linear waveguide.

A sixth aspect of the present invention is the optical 90-degree hybrid according to the fifth aspect, wherein in the first to fourth paths, phase trimming heaters are arranged, respectively, and each optical path length of the third path and the fourth path can be adjusted by performing phase trimming by driving any one of a heater arranged in the third path and a heater arranged in the fourth path of the phase trimming heaters.

A seventh aspect of the present invention is the optical 90-degree hybrid according to the first aspect, wherein the second coupler is a directional coupler.

An eighth aspect of the present invention is the optical 90-degree hybrid according to the seventh aspect, wherein the directional coupler is a low wavelength dependency directional coupler.

A ninth aspect of the present invention is the optical 90-degree hybrid according to the first aspect, wherein within the planar lightwave circuit of the PLC chip, two of the 90-degree hybrid circuits are formed.

According to the present invention, it is possible to realize an optical 90-degree hybrid which can be downsized and for which the manufacturing cost is reduced.

### BRIEF DESCRIPTION OF THE DRAWINGS

FIG. 1 is a schematic configuration diagram showing an optical 90-degree hybrid according to a first embodiment of the present invention.

FIG. 2 is a schematic configuration diagram showing an optical 90-degree hybrid according to a second embodiment of the present invention.

FIG. 3 is a diagram showing a graph representing phase error wavelength characteristics possessed by a conventional optical 90-degree hybrid shown in FIG. 6.

FIG. 4 is a diagram showing a graph representing phase error wavelength characteristics possessed by the optical 90-degree hybrid shown in FIG. 2.

FIG. 5 is a diagram showing a graph representing phase error wavelength characteristics possessed by the conventional optical 90-degree hybrid shown in FIG. 6.

FIG. 6 is a schematic configuration diagram showing a conventional optical 90-degree hybrid.

FIG. 7 is a diagram for explaining an example in which an optical path difference between two waveguides is adjusted according to the first embodiment of the present invention.

### DESCRIPTION OF EMBODIMENTS

Hereinafter, embodiments that embody the present invention are explained based on the drawing. The same reference numeral is attached to the same part in the explanation of each embodiment and its duplicated explanation is omitted.

### First Embodiment

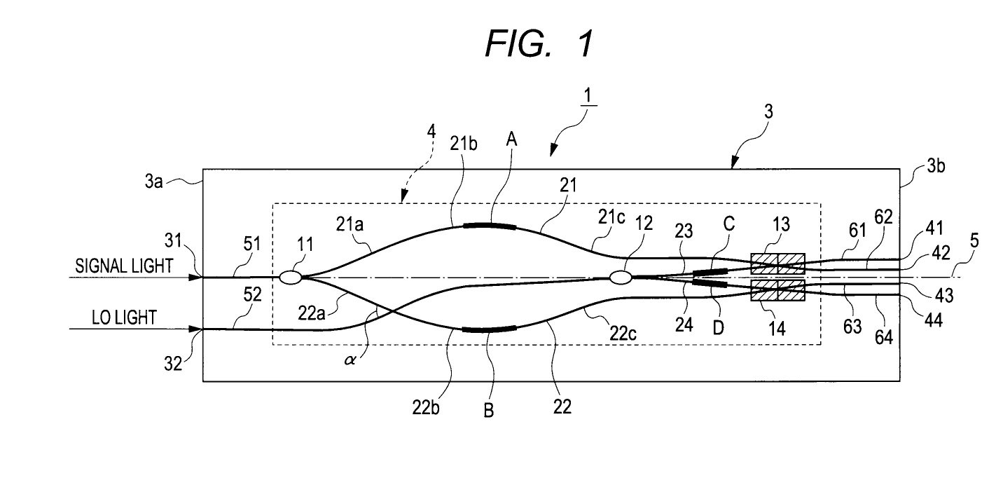

An optical 90-degree hybrid 1 according to a first embodiment is explained based on FIG. 1.

As shown in FIG. 1, the optical 90-degree hybrid 1 is a device in which a 90-degree hybrid circuit 4, which mixes signal light and local oscillation light (LO light), separates the signal light into orthogonal components I, Q, and outputs the components, is formed within a planar lightwave circuit of a PLC chip 3.

On the PLC chip 3, a planar lightwave circuit (PLC) including a plurality of waveguides having a core and cladding by combining the optical fiber manufacturing technique and the semiconductor microfabrication technique is formed on a substrate, such as a quartz substrate and silicon substrate, not shown schematically. This PLC is, for example, a quartz-based PLC.

The 90-degree hybrid circuit 4 comprises a first coupler 11 and a second coupler 12 that respectively branch signal light and local oscillation light (LO light), a first path 21 and a second path 22 through which the signal light branched by the first coupler 11 propagates respectively, a third path 23 and a fourth path 24 through which the LO light branched by the second coupler 12 propagates respectively, a third coupler 13 that combines the signal light having propagated through the first path 21 and the LO light having propagated through the third path 23, and a fourth coupler 14 that combines the signal light having propagated through the second path 22 and the LO light having propagated through the fourth path 24. The signal light is, for example, a phase-modulated signal such as a QPSK signal.

In the 90-degree hybrid circuit 4 shown in FIG. 1, between one of output ports of the first coupler 11 and one of input ports of the third coupler 13, the first path (arm waveguide) 21 is connected. Between the other output port of the first coupler 11 and one of input ports of the fourth coupler 14, the second path (arm waveguide) is connected. The optical path lengths of the first path 21 and the second path 22 are the same.

Further, between one of output ports of the second coupler 12 and the other input port of the third coupler 13, the third path (arm waveguide) 23 is connected. Between the other output port of the second coupler 12 and the other input port of the fourth coupler 14, the fourth path (arm waveguide) 24 is connected.

The 90-degree hybrid circuit 4 is configured so that a phase difference of 90 degrees is given between the beams of LO light that propagate through the third path 23 and the fourth path 24, respectively. In the present embodiment, each optical path length of the third path 23 and the fourth path 24 is set so that the optical path difference between both the paths 23, 24 is 90 degrees in terms of phase. That is, a phase difference of 90 degrees is given between both the beams of LO light by changing the optical path lengths (increasing or reducing the optical path lengths) of the third path 23 and the fourth path through which the LO light propagates respectively. In general, a phase difference Δφ obtained when giving an optical path length difference 2 ΔL between paths is expressed by the following (formula 1).

Δφ=(4πnΔL/λ) (formula 1)

Here, n is an effective refractive index of a waveguide and λ, is the wavelength of light to be considered.

The 90-degree hybrid circuit 4 is characterized in the configuration in which the second coupler 12, the third path 23, and the fourth path 24 are formed between the first path 21 and the second path 22. That is, the second coupler 12, the third path 23, and the fourth path form a nesting (nesting structure) between the first path 21 and the second path 22.

The first coupler 11 is a Y-branch coupler. The second coupler 12 is a Y-branch coupler. The third coupler 13 and the fourth coupler 14 are directional couplers (DC) or wavelength insensitive directional couplers (WINC).

In the 90-degree hybrid circuit 4, as shown in FIG. 1, the first path 21 and the second path 22, and the third path 23 and the fourth path are formed symmetrical about a virtual center line 5 connecting each center part of an input end 3a and an output end 3b on the left and right sides of the PLC chip 3.

At the input end 3a, a first input port 31 and a second input port 32 to which signal light and LO light are input, respectively, are provided. At the output end 3b, four output ports, that is, a first output port 41 to a fourth output port 44 are provided.

In the present embodiment, the first input port 31 is provided at the center part of the input end 3a and the second input port 32 in a position slightly shifted downward from the center part. The first output port 41 and the second output port are provided in positions slightly shifted upward from the center part of the output end 3b and the third output port 43 and the fourth output port 44 in positions slightly shifted downward from the center part, respectively.

Between the first input port 31 and the first coupler 11, a first input waveguide 51 for signal light extending along the virtual center line 5 at the center part in the longitudinal direction of the PLC chip 3 is formed. Here, the longitudinal direction of the PLC chip 3 is the vertical direction in the plane of the paper of FIG. 1, that is, the short hand direction (short side direction) of the rectangular PLC chip 3.

Between the second input port 32 and the second coupler 12, a second input waveguide 52 for LO light extending in the horizontal direction of the PLC chip 3 at a position shifted from the center part in the longitudinal direction of the PLC chip 3 and intersecting the second path 22 is formed. Here, the horizontal direction of the PLC chip 3 is the left-right direction in FIG. 1, that is, the longitudinal direction (long side direction) of the rectangular PLC chip 3.

The two output ports of the third coupler 13, and the first output port 41 and the second output port 42 are connected by a first output waveguide 61 and a second output waveguide 62, respectively. The two output ports of the fourth coupler 14, and the third output port 43 and the fourth output port 44 are connected by a third output waveguide 63 and a fourth output waveguide 64, respectively. Further, the first output waveguide 61 and the second output waveguide 62, and the third output waveguide 63 and the fourth output waveguide 64 are formed symmetrical about the virtual center line 5.

The first path 21 and the second path 22 respectively have waveguides 21a and 22a including bent waveguides extending in the direction in which both the waveguides become more distant from the virtual center line 5 after branched by the first coupler 11, linear waveguides 21b and 22b extending in parallel in positions symmetrical about the virtual center line 5 from the waveguides, and waveguides 21c and 22c including bent waveguides extending in the direction in which both the waveguides become closer to the virtual center line 5.

In the 90-degree hybrid circuit 4, after LO light is branched into two beams by the second coupler 12, it is necessary to give a phase difference of 90 degrees between both the beams of LO light that propagate through the two paths 23, 24, and therefore, a structure is adopted, in which the optical path lengths of the third path 23 and the fourth path 24 can be adjusted arbitrarily.

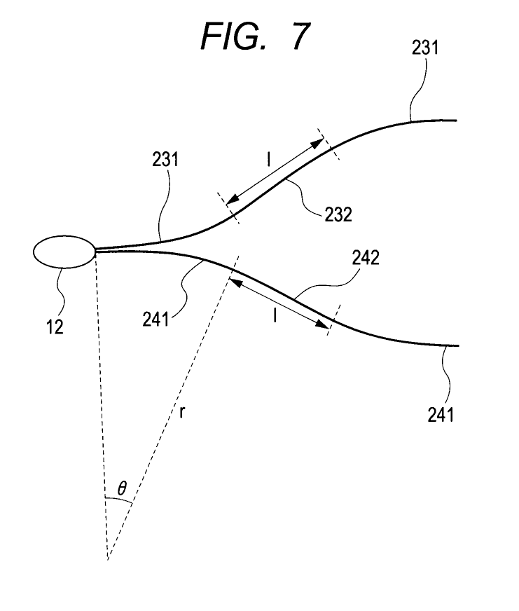

That is, as shown in FIG. 7, the third path and the fourth path 24 respectively have bent waveguides 231, 241 and linear waveguides 232, 242. A bend radius r and a rotation angle θ of each of the bent waveguides 231, 241 are all the same. The structure is such that under the conditions that the bend radius r of the bent waveguide of each of the paths 23, 24 is fixed to an optimum value, for example, 2,000 μm, it is possible to set the optical path difference between the third path 23 and the fourth path 24 to 90 degrees in terms of phase by adjusting at least one of the rotation angle θ of each bent waveguide and a length l of each linear waveguide.

It is also possible to adjust the bend radius r, but, from the standpoint that the 90-degree hybrid circuit 4 is downsized, it is preferable to fix the bend radius r of the bent waveguide to an optimum value and adjust at least one of the rotation angle θ of each bent waveguide and the length l of each linear waveguide as described above.

Further, an intersection angle α (see FIG. 1) at which the second path 22 and the first input waveguide 52 intersect is set to a range of 60° to 90°. It is desirable for the intersection angle α to be not less than 60°. If the intersection angle α is less than 60°, a loss (crosstalk) occurs at the intersecting part of the second path 22 and the input waveguide 52. When the intersection angle α is set to 90°, the loss at the intersecting part is at its minimum.

In the 90-degree hybrid circuit 4, phase trimming heaters A to D may be arranged respectively in the four paths 21 to 24. It is possible to adjust each optical path length of the third path 23 and the fourth path 24 by performing phase trimming by driving one of the heater C arranged in the third path 23 and the heater D arranged in the fourth path 24 of the four heaters A to D.

That is, when the phases of the orthogonal components I, Q of the signal light output from the output ports 41 to 44 are shifted, it is possible to perform phase trimming by driving one of the heaters C, D. Further, the heaters C, D are arranged in the paths 23, 24, respectively, through which LO light propagates, and therefore, it is possible to perform trimming for each of positive and negative phase errors.

When the heaters A to D are provided in all the paths 21 to 24, it is possible to obtain the 90-degree hybrid circuit 4 having very stable output characteristics by making uniform all the optical characteristics of the paths 21 to 24.

Even if the phase trimming heater is not arranged in the four paths 21 to 24 in the 90-degree hybrid circuit 4, it is possible to perform phase trimming by irradiating ultraviolet laser light after injecting hydrogen.

According to the first embodiment having the above configuration, the following working and effect are achieved.
(1) The second coupler 12, the third path 23, and the fourth path 24 are formed between the first path 21 and the second path 22, and therefore, the overall size of the 90-degree hybrid circuit 4, in particular, the size in the longitudinal direction of the PLC chip (direction perpendicular to the direction in which signal light and LO light propagate) is reduced and downsizing of the PLC chip 3 is enabled. Due to this, it is possible to realize a compact optical 90-degree hybrid.
(2) Downsizing of the PLC chip 3 is enabled, and thereby, it is possible to reduce the manufacturing cost by increasing the number of the 90-degree hybrid circuits 4 that can be manufactured on one wafer, that is, the number of the PLC chips 3 that can be obtained from one wafer.
(3) The first path 21 and the second path 22 are formed symmetrical about the virtual center line 5 connecting each center part of the input end 3a and the output end 3b on the left and right sides of the PLC chip 3, and therefore, both the beams of signal light propagating through both the paths 21, 22 may reach the couplers 13 and 14, respectively, without a time difference (skew). Further, the structure is symmetrical about the virtual center line 5, and therefore, the loss becomes uniform.
(4) Downsizing of the PLC chip 3 is enabled and at the same time, the third path 23 and the fourth path 24 are formed substantially symmetrical about the virtual center line 5 with short distances, and therefore, it is possible to suppress a phase error from occurring between both the beams of LO light propagating through both the paths 23, 24, respectively. As a result of that, it is possible to obtain very stable output characteristics. Further, the structure is symmetrical about the virtual center line 5, and therefore, no skew or phase error occurs in addition to that the loss becomes uniform.
(5) A broadband operation (for example, the use in CL wavelength band; 1,530 to 1,620 nm) is available and it is possible to realize a low-loss and compact optical 90-degree hybrid.
(6) The Y-branch coupler is used as the input side coupler that branches signal light and LO light, respectively, and WINC is used as the output side coupler that combines LO light and signal light (causes LO light and signal light to interfere with each other). Because of this, it is possible to realize an optical 90-degree hybrid capable of being downsized and made wavelength insensitive and of stable operation in a broadband.
(7) The structure is such that the optical path lengths of the third path 23 and the fourth path 24 can be adjusted arbitrarily by adjusting the rotation angle θ of each bent waveguide and the length l of each linear waveguide under the condition that the bend radius r of each bent waveguide of the third path 23 and the fourth path 24 is fixed. Because of this, by adjusting the rotation angle θ and the length l, it is possible to freely change the optical path lengths of the paths 23, 24 and to increase the degree of freedom in design. In particular, when the condition that the bend radius of each bent waveguide is fixed to an optimum value is set, it is possible to freely change the optical path lengths of the paths 23, 24 by adjusting each parameter described above, and therefore, it is made easy to design optical 90-degree hybrids in accordance with various specifications.
(8) By setting the intersection angle α (see FIG. 1) at which the second path 22 and the input waveguide 52 intersect to a range of 60° to 90°, it is possible to suppress a loss at the intersection of the second path 22 and the input waveguide 52.
(9) The phase trimming when the phases of the orthogonal components I, Q shift is enabled by driving any one of the heaters C, D.
(10) The output ports 41 to 44 are arranged concentratedly in the center part of the output end 3b, and therefore, it is made possible to make optical connection between the output waveguides 61 to 64 and an optical fiber array or balanced photodiode (B-PD) array, not shown schematically.

### Second Embodiment

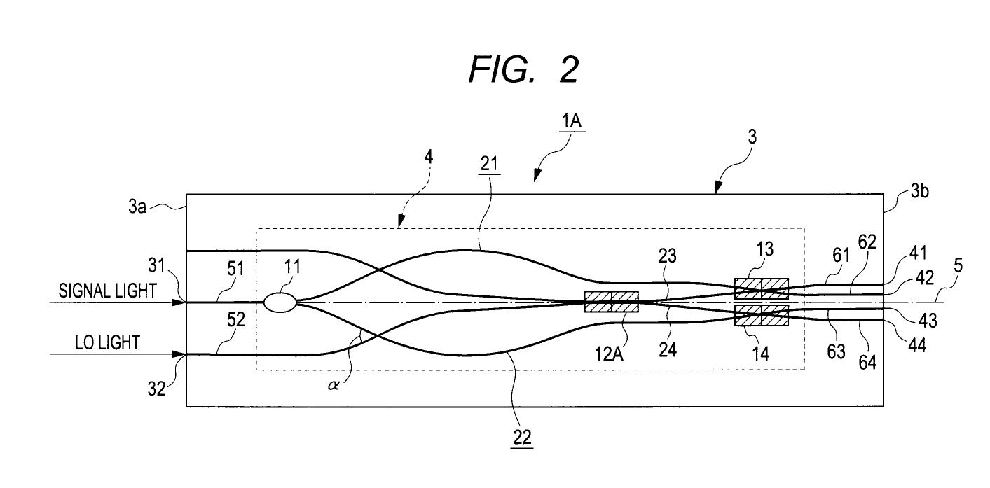

Next, an optical 90-degree hybrid 1A according to a second embodiment is explained based on FIG. 2. In the optical 90-degree hybrid shown in FIG. 1, as the second coupler 12 that branches LO light, the Y-branch coupler is used and a phase difference of 90 degrees is given between both the beams of LO light by changing the optical path lengths of the third path 23 and the fourth path 24 through which LO light propagates, respectively. Specifically, for example, it is assumed that Δφ=π/2, λ=1.55, n=1.456 and formula 1 is solved and an optical path difference of 2 ΔL=0.266 μm is given between both the paths.

In contrast to this, in the optical 90-degree hybrid 1A, as shown in FIG. 2, after the waveguides are set so that the optical path lengths of the third path 23 and the fourth path 24 are the same in the optical 90-degree hybrid 1, a directional coupler (DC) 12A is used as the second coupler that branches LO light. In the present embodiment, the properties that the directional coupler does not depend on the wavelength of input light and the phase of cross-port output light is delayed 90 degrees from that of through-port output light are utilized and the cross-port output light of the directional coupler 12A is made to delay 90 degrees in phase from the through-port output light, and thereby, a phase difference of 90 degrees is given between both the beams of LO light propagating through the third path 23 and the fourth path 24, respectively.

Further, between the second input port and one of two input ports of the DC 12A, the second input waveguide 52 for LO light is formed, which extends in the horizontal direction of the PLC chip 3 at the position shifted from the center part in the longitudinal direction of the PLC chip and which intersects the second path 22. Other configurations are the same as those of the optical 90-degree hybrid 1.

As described above, the features of the optical 90-degree hybrid 1A shown in FIG. 2 lie in being wavelength insensitive and that a phase difference of 90 degrees is given between both the beams of LO light by positively utilizing the properties inherent in the directional coupler that a phase difference of 90 degrees is given between the cross-port output light and the through-port output light.

In the conventional optical 90-degree hybrid described above, a phase difference Δφ of 90 degrees is given between both the beams of LO light by changing the optical path lengths of the two paths through which the LO light propagates.

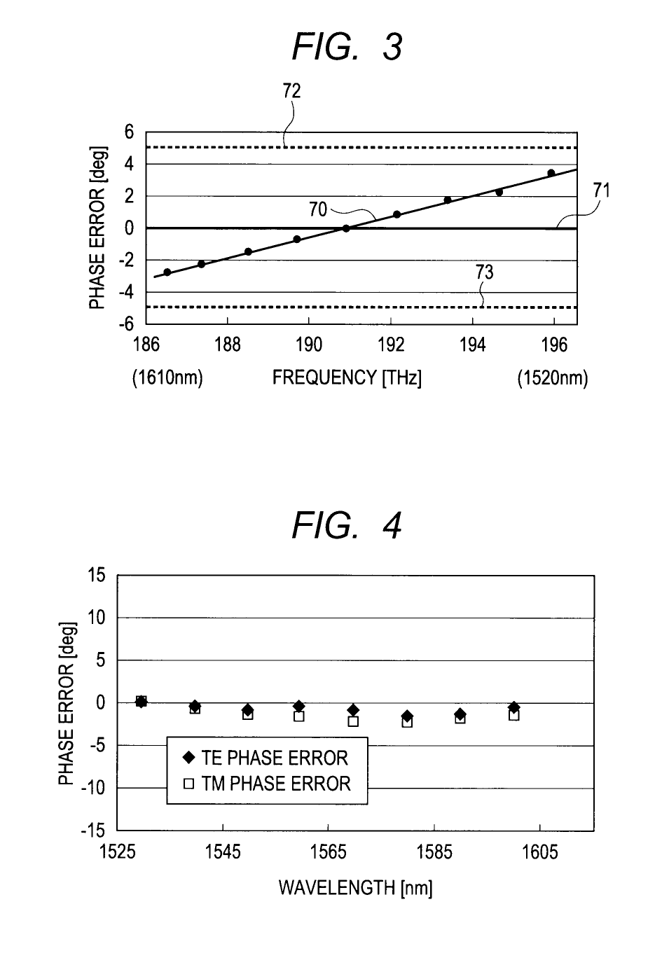

Because the wavelength λ, is included in the above (formula 1) expressing the phase difference Δφ, in the conventional optical 90-degree hybrid in which the optical path lengths of the two paths through which LO light propagates are set so that the phase difference Δφ of 90 degrees is given between both the beams of LO light with the wavelength λ, when the wavelength changes, a shift (phase error) occurs essentially in the phase difference Δφ between both the beams of LO light propagating through the two paths (see the graph in FIG. 3). That is, the phase difference Δφ between both the beams of LO light propagating through the two paths the optical path lengths of which are set so that the phase difference Δφ of 90 degrees is given between both the beams of LO light deviates from the phase difference Δφ of 90 degrees when the wavelength changes. Further, because of errors at the time of manufacture of PLC, when the refractive index n or the optical path length difference ΔL of glass changes, a phase error also occurs as a result.

FIG. 3 is a graph representing the wavelength characteristics of phase errors possessed by the above-mentioned conventional optical 90-degree hybrid. In the graph in FIG. 3, reference numeral 71 denotes a level at which the phase error is zero degrees (the phase difference is a desired phase difference=90 degrees), reference numeral 72 denotes a level at which the phase error is +5 degrees (phase difference=95 degrees), and reference numeral 73 denotes a level at which the phase error is −5 degrees (phase difference=85 degrees), respectively.

In the above-mentioned conventional optical 90-degree hybrid, as shown by a straight line 70 in FIG. 3, when the wavelength λ of LO light changes from the designed wavelength, for example, 1.57 μm (frequency is about 191 THz) to a wavelength on the shorter wavelength side (higher frequency side), the phase difference gradually becomes larger than 90 degrees. On the contrary, when the wavelength λ of LO light changes from the designed wavelength to a wavelength on the longer wavelength side (lower frequency side), the phase difference gradually becomes smaller than 90 degrees.

Because of the above, in the optical 90-degree hybrid shown in FIG. 1 or in the above-mentioned conventional optical 90-degree hybrid, it is necessary to adjust the phase difference Δφ between both the beams of LO light by phase trimming so that the phase error falls within a tolerance range between +5 degrees (phase difference=95 degrees) to −5 degrees (phase difference =85 degrees) for all the wavelengths in a broadband, such as the C-L band.

The phase trimming is performed by driving the heater provided in either of the two paths through which branched LO light propagates, or by means of UV trimming that permanently changes the refractive index of the path by irradiating either of the two paths with UV light without using any heater. However, each phase trimming needs to be performed for each manufactured PLC chip and is very complicated, and therefore, forming one of factors that raise the manufacturing cost.

A function correction method of an optical 90-degree hybrid to correct such a phase error is also proposed (see Patent Document 1).

As described above, in order to solve the above-described problems in the optical 90-degree hybrid in which the phase difference Δφ of degrees is given between both the beams of LO light by changing the optical path lengths of the two paths through which LO light propagates, the inventors of the present invention have invented the optical 90-degree hybrid 1A according to the second embodiment as a result of assiduous research.

The optical 90-degree hybrid 1A according to the second embodiment of the present invention having the aspect in FIG. 2 was manufactured as a trial hybrid and the phase errors were evaluated. The result is shown in FIG. 4. From the result in FIG. 4, it can be seen that when the optical 90-degree hybrid 1A of the present invention is used, the phase errors are obtained in the range from about −2 degrees to 0 degrees in a very wide wavelength range from 1,530 nm to 1,600 nm and excellent phase characteristics are exhibited without the need of phase trimming.

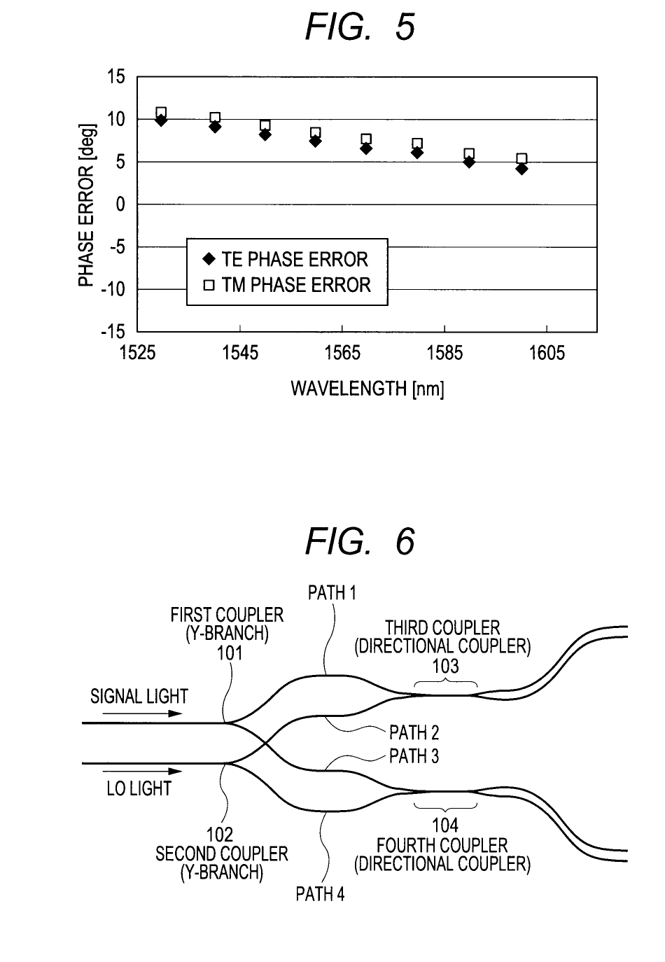

In contrast to this, the conventional optical 90-degree hybrid having the aspect in FIG. 6 was manufactured as a trial hybrid at the same time and the phase errors were evaluated. The result is shown in FIG. 5. In the wavelength range from 1,530 nm to 1,600 nm, the phase error changes from about 10 degrees to 4 degrees. In order to reduce the phase error to the range of ±5 degrees, it is necessary to perform phase trimming, but, even if the phase trimming is performed, the wavelength characteristics of the phase error do not disappear, and therefore, the phase characteristics are not so excellent compared to the result in FIG. 4.

According to the second embodiment having the above configuration, the following working and effect are achieved besides the working and effect achieved by the above-mentioned first embodiment.
(1) As the second coupler that branches LO light, the DC 12A is used and the phenomenon that the cross-port output light of the DC 12A is delayed 90 degrees in phase compared to the through-port output light is utilized, and thereby, a phase difference of 90 degrees is given between the beams of LO light propagating through the third path 23 and the fourth path 24. Because of this, it is possible to realize an optical 90-degree hybrid that is wavelength insensitive and in which no phase error exists theoretically.

That is, it is possible to realize an optical 90-degree hybrid in which no phase error occurs even when the wavelength is changed in a broadband, such as the C-L band.
(2) The wavelength characteristics of phase error as shown by the graph in FIG. 3 are eliminated in principle, and therefore, the possibility is high that such complicated phase trimming as described above may be obviated if the specifications are the same, for example, the specifications are those with which the tolerance range of the phase error is a range from +5 degrees (phase difference=95 degrees) to −5 degrees (phase difference=85 degrees). Due to this, it is possible to reduce the manufacturing cost.
(3) The method for correcting an error from the ideal relative phase difference between the optical path lengths of the optical 90-degree hybrid as in the invention described in Patent Document 1 becomes unnecessary.

In the optical 90-degree hybrid 1A shown in FIG. 2, the DC 12A used as the second coupler that branches LO light is insensitive to wavelength as to the phase and gives a phase difference of 90 degrees between the cross-port output light and the through-port output light for any wavelength, but, is sensitive to wavelength as to the intensity of both the beams of output light. It is preferable to use a low wavelength dependency DC having a narrower waveguide width (core width) at the connection part and a narrower waveguide separation at the connection part than those of the normal DC, that is, a so-called narrow-width DC.

Further, in the optical 90-degree hybrid 1A shown in FIG. 2, the configuration is explained, in which the DC 12A that is used as the second coupler characteristic to the present embodiment, the third path 23, and the fourth path 24 are formed between the first path 21 and the second path 22, but, the present invention is not limited to this configuration.

That is, it is possible to apply the present invention to an optical 90-degree hybrid having the following configuration.

The optical 90-degree hybrid may be one characterized in that a 90-degree hybrid circuit that mixes signal light and local oscillation light and separates the signal light into the orthogonal components I, Q and outputs the components is formed within a planar lightwave circuit of a PLC chip, the optical 90-degree hybrid including:
a first coupler and a second coupler that branch the signal light and local oscillation light, respectively;
a first path and a second path through which signal light branched by the first coupler propagates, respectively;
a third path and a fourth path through which LO light branched by the second coupler propagates, respectively;
a third coupler that combines the signal light having propagated through the first path and the LO light having propagated through the third path; and
a fourth coupler that combines the signal light having propagated through the second path and the LO light having propagated through the fourth path, and wherein
a directional coupler is used as the second coupler and a phase difference of 90 degrees is given between both the beams of LO light propagating through the third path and the fourth path, respectively, by utilizing the phenomenon that the cross-port output light of the directional coupler is delayed 90 degrees in phase compared to the through-port output light.

In each of the embodiments described above, the optical 90-degree hybrid in which one 90-degree hybrid circuit is formed on the PLC chip is explained, but, it is also possible to apply the present invention to an optical 90-degree hybrid in which two 90-degree hybrid circuits are formed on the PLC chip 3 and which can be used in a DP-QPSK receiver etc.

Further, it is also possible to apply the present invention to an optical 90-degree hybrid in which two 90-degree hybrid circuits and a polarization beam splitter (PBS) are formed on the PLC chip 3.

1. An optical 90-degree hybrid in which a 90-degree hybrid circuit that mixes modulated signal light and local oscillation light, separates the signal light into orthogonal components I, Q, and outputs the components is formed within a planar lightwave circuit of a PLC chip,
the 90-degree hybrid circuit comprising:
a first coupler that branches the signal light;
a second coupler that branches the local oscillation light;
a first path and a second path through which the signal light branched by the first coupler propagates, respectively;
a third path and a fourth path through which the local oscillation light branched by the second coupler propagates, respectively;
a third coupler that combines the signal light having propagated through the first path and the local oscillation light having propagated through the third path; and
a fourth coupler that combines the signal light having propagated through the second path and the local oscillation light having propagated through the fourth path, wherein
the 90-degree hybrid circuit is configured so that a phase difference of 90 degrees is given between the beams of local oscillation light propagating through the third path and the fourth path, and
the second coupler, the third path, and the fourth path are formed between the first path and the second path.

2. The optical 90-degree hybrid according to claim 1, wherein
the first path and the second path, and the third path and the fourth path are formed symmetrical about a virtual center line connecting each center part of an input end and an output end of the PLC chip.

3. The optical 90-degree hybrid according to claim 2, wherein
at the input end, a first input port to which the signal light is input and a second input port to which the local oscillation light is input are provided, respectively, and
at the output end, first to fourth output ports are provided, respectively.

4. The optical 90-degree hybrid according to claim 3, wherein
between the first input port and the first coupler, a first input waveguide for signal light is formed,
between the second input port and the second coupler, a second input waveguide for local oscillation light intersecting any one of the first path and the second path is formed, and
a first and a second output waveguide that connect two output ports of the third coupler and the first and second output ports, and a third and a fourth output waveguide that connect two output ports of the fourth coupler and the third and fourth output ports are formed symmetrical about the virtual center line, respectively.

5. The optical 90-degree hybrid according to claim 1, wherein
the third path and the fourth path have a bent waveguide and a linear waveguide, respectively, and the optical path difference between the third path and the fourth path is set to 90 degrees in terms of phase by adjusting at least one of the rotation angle of the bent waveguide and the length of the linear waveguide.

6. The optical 90-degree hybrid according to claim 5, wherein
in the first to fourth paths, phase trimming heaters are arranged, respectively, and
each optical path length of the third path and the fourth path can be adjusted by performing phase trimming by driving any one of a heater arranged in the third path and a heater arranged in the fourth path of the phase trimming heaters.

7. The optical 90-degree hybrid according to claim 1, wherein
the second coupler is a directional coupler.

8. The optical 90-degree hybrid according to claim 7, wherein
the directional coupler is a low wavelength dependency directional coupler.

9. The optical 90-degree hybrid according to claim 1, wherein
within the planar lightwave circuit of the PLC chip, two of the 90-degree hybrid circuits are formed.
